(19) United States
(12) Patent Application Publication
(10) Pub. No.: US 2001/0040189 A1
(43) Pub. Date: Nov. 15, 2001

(54) TAR HEATING AND SPRAYING APPARATUS

(76) Inventor: JULIAN CASTANO RESTREPO, ANTIOQUIA (CO)

Correspondence Address: NATH & ASSOCIATES, SIXTH FLOOR, 1030 FIFTEENTH STREET NW, WASHINGTON, DC, 20005

(21) Appl. No.: 09/383,147

(22) Filed: Aug. 26, 1999

(30) Foreign Application Priority Data
Sep. 3, 1998 (CO) 98/050,501

(51) Int. Cl. B05B 1/24

(52) U.S. Cl. 239/139; 239/135

(57) ABSTRACT

The tar sprayer subject of the present application is conformed by a temperature system, a heating tank, a supply tank, a compressor and a spraygun.

It permits the application of tar in industrial waterproofing and road asphalting processes at lesser cost and time, since it may be applied in a continuos manner, it facilitates the use of tar as waterproofer in areas which are difficult to access in the building industry.

At the present time, tar is applied manually using conventional heating systems to keep it melted and then transporting it to the desired place for its application.

The subject sprayer permits the application of tar in industrial waterproofing and road asphalting processes at lesser cost and time, since it may be applied in a continuous manner, it prevents the ambient pollution caused by the conventional heating method and it facilitates the use of tar as waterproofer in areas which are difficult to access in the building industry.

### DETAILED DESCRIPTION OF THE INVENTION

The subject tar sprayer (1) is conformed by a temperature system which contains a gas burner (2) that has an electric motor (3) for its oxygenation, said burner (2) is fed by a pipe (4), of propane or natural gas, which permits the regulation of gas pressure for its adequate functioning. The oxygenation of the gas burner is done by an electric motor (3) fed with energy produced by an electric plant (5), which also functions with gas; this plant also generates energy for the control board and lights. The gas necessary for the operation of this plant comes from the same source as the burner's supply source. The electric plant (5) has a generator with a 115 to 220 V output of alternating current and twelve volts of direct current.

The system has a heating tank (6) that comprises three zones, an interior zone or chamber (7), where the solid tar arrives through a duct (18), coming from the spout tank (17), the tar is melted at a temperature which does not exceed 250° C. An intermediate zone (9), where the burner's mouth (10) enters in such a way that the flame crashes with the interior cylinder or interior zone (7), generating a hot air whirlwind. Finally, an exterior zone (11), which corresponds to the protector shell, made of highly resistant steel; between the latest and the intermediate zone (9), there is a temperature insulating material of glass wool, light and of uniform texture slightly softened with lubricant oil. On the superior part of said shell appears a holding ring (12) that permits the fixture or union between the heating tank and the shell; in its base (13), internally it presents a plurality of arms (14), over which the conic base of the tank is attached. The chamber or internal heating zone (7), also has a lid (15), made of steel with a neoprene pack to avoid a loss of pressure and temperature; and in its superior part there are installed conventional elements such as a security air valve (16C), pressure gauge, air valve or check valve (16), connected to the compressor (16A) and thermocupla; said lid is adjusted through a plurality of screws, thus enabling the airtight closing.

The supply tank (17) has an intermediate zone (17A) and a temperature insulator (17B), and is connected to the heating tank (6) through a hose (18), which is incorporated to a revolving pump (19), thus enabling the suction for the regular and constant supply of tar. The supply tank (17) has a lid preferably held by eight screws, which has an “O” ring to avoid the escape of gases to the outside, it also presents a security valve and a check for the connection of a hose to the cistern (tank) car, which is used in case of extensive zones waterproofing. Said car consists of a cylindrical tank with a temperature insulating system and a hot oil chamber. The vent (8), which goes to the intermediate zone (17A) of the supply tank, transports the hot air from the intermediate zone (9), from the heating tank (6), to the intermediate zone (17A), which enables the easy passage of tar to the principal bumer. From the intermediate zone 9 of the heating tank starts a hose (20A) which is connected to a hose (20), in its intermediate part, where the hose (20) is conformed by two zones, one interior that receives the tar and one intermediate which receives the heat, thus enabling the passage of the liquid tar through the sprayer hose (20), up to the spraygun (21), which presents two entries, 21A and 21B, equipped with their respective fittings, for the income of hot air and tar, respectively.

### BRIEF DESCRIPTION OF THE FIGURES

FIG. 1: Shows a perspective of the pieces of the heating tank, allowing a view of its components, such as the interior zone, the shell, the holding ring, the lid and the base where the arms are.

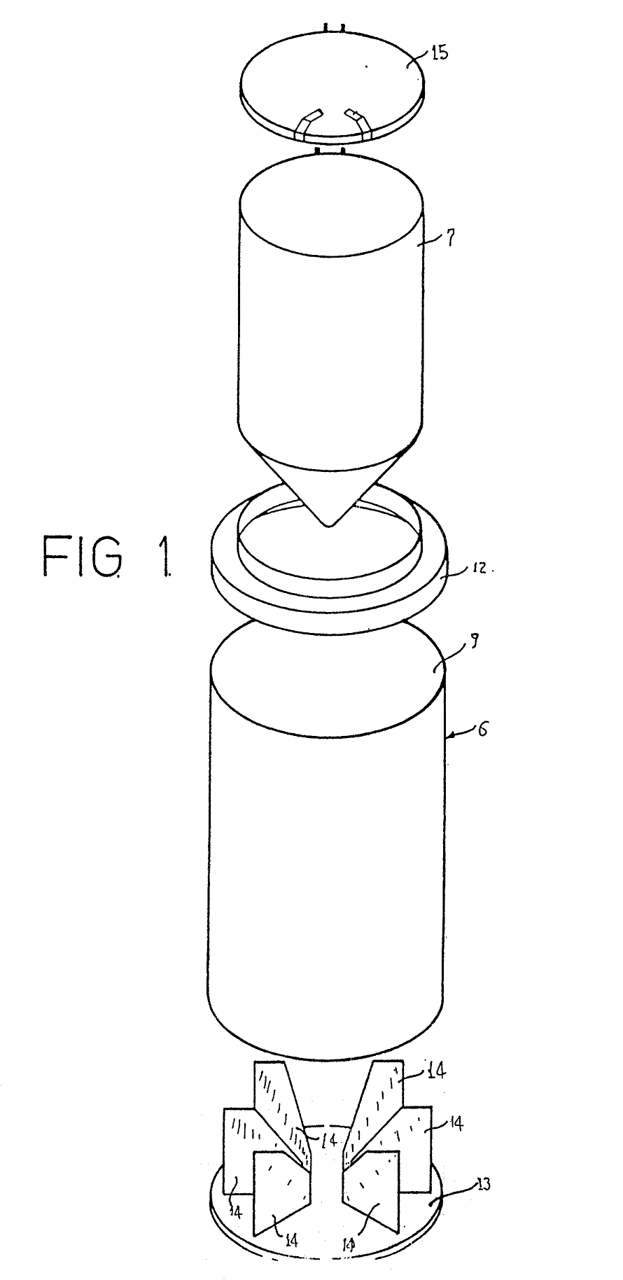

FIG. 2: Shows a longitudinal cut, allowing a view of the manner of assembly of the different components of the heating tank.

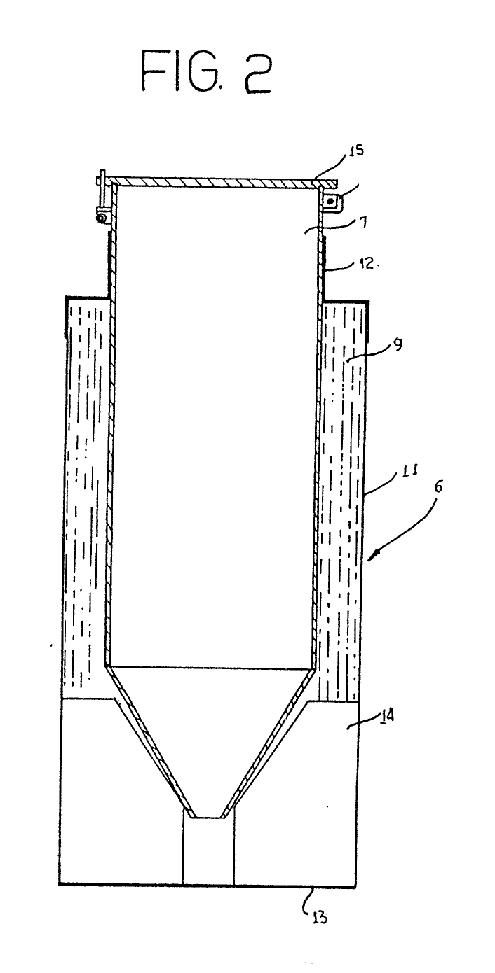

FIG. 3: Shows a lateral cut view enabling the observation of the manner in which the different components of the tar sprayer are interconnected, such as the energy plant, the gas supply, the burner; the heating tank the spout tank and the spraygun.

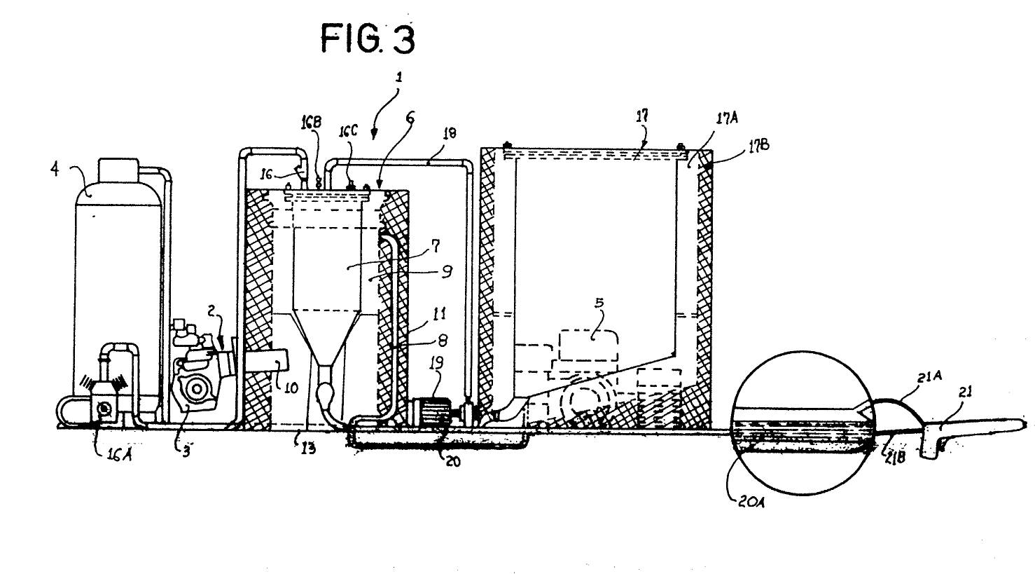

1. Tar sprayer (1) characterized by being conformed by: a temperature system which is conformed by a gas burner (2), that has an electric motor (3), said burner (2), is fed by a pipe (4), of propane or natural gas. The electric motor (3), of oxygenation of the gas burner, is fed with energy produced by an electric plant (5), which also functions with gas coming from the same source as the burner; this plant also generates energy for the control board and lights.
The sprayer also has a heating tank (6) that comprises three zones, an interior zone or chamber (7), an intermediate zone (9), and an exterior zone or shell (11):
the dense tar comes through a duct (18), coming from a supply tank (17).

2. Tar sprayer in agreement with claim 1, characterized because the heating tank (6) has three zones. An interior zone or chamber (7) where the tar is melted at a temperature which does not exceed 250° C. An intermediate zone (9), where the burner's mouth (10) enters in such a way that the flame crashes with the interior cylinder or interior zone (7), generating a hot air whirlwind; between the external zone (11) and the intermediate zone (9) there is a temperature insulation of glass wool. The exterior zone (11) corresponds to the protector shell. On the superior part of said shell appears a holding ring (12), for the fixture or union between the heating tank and the shell, in the same way in its base (13), internally it presents a plurality of arms (14), over which the conic base of the tank is attached. The heating chamber (7), also has a lid (15), with a neoprene pack and in its superior part there are installed conventional elements such as a security air valve (16C), pressure gauge, air valve or check valve (16), where the compressor is connected (16A) for the spraying and thermocupla (16B); said lid is airtight adjusted through a plurality of screws.

3. Tar sprayer in agreement with claim 1, characterized because the supply tank (17), is connected to the heating tank (6) through a hose (18), which is incorporated to a revolving pump (19). The supply tank (17) has a lid The supply tank (17) has a lid held by eight screws, which has an “O” ring, it also presents a security valve and an opening for the connection of a hose to the cistern (tank) car. The vent (8), which goes to the intermediate zone (17A) of the supply tank, transports the hot air from the intermediate zone (9), from the heating tank (6), to the intermediate zone (17A), of the supply tank which enables the easy passage of tar to the principal burner. From the intermediate zone 9 of the heating tank, starts a hose (20A) which is connected to a hose (20), in its intermediate part, where the hose (20) is conformed by two zones, one interior that receives the tar and one intermediate which receives heat, in such a manner that the liquid tar comes through the sprayer hose (20), up to the spraygun (21), which presents two entries, 21A and 21B, for the income of hot air and tar, respectively.
